(19) United States
(12) Patent Application Publication
(10) Pub. No.: US 2014/0189555 A1
(43) Pub. Date: Jul. 3, 2014

(54) DISTANCE-ASSISTED CONTROL OF DISPLAY ABSTRACTION AND INTERACTION MODE

(71) Applicants: Roland ECKL, Forchheim (DE); Asa MacWilliams, Fuerstenfeldbruck (DE)

(72) Inventors: Roland ECKL, Forchheim (DE); Asa MacWilliams, Fuerstenfeldbruck (DE)

(73) Assignee: SIEMENS AKTIENGESELLSCHAFT, Munich (DE)

(21) Appl. No.: 14/141,795

(22) Filed: Dec. 27, 2013

(30) Foreign Application Priority Data
Dec. 27, 2012 (DE) 10 2012 224 394.1

(51) Int. Cl. G06F 3/01

(52) U.S. Cl. CPC G06F 3/017
USPC 715/765

(57) ABSTRACT

An interaction device features a user interface which includes an output device; a proximity sensor; a logic module; and software which can be executed on the logic module and is designed to evaluate data from the proximity sensor and to control the user interface. The proximity sensor is designed to detect when a user approaches in the visual range of the proximity sensor. The software is designed to use the detected approach to customize a presentation of information on the output device and to refine the presentation of information as the distance between the user and the proximity sensor decreases.

### CROSS REFERENCE TO RELATED APPLICATIONS

This application is based on and hereby claims priority to German Application No. 10 2012 224 394.1 filed on Dec. 27, 2012, the contents of which are hereby incorporated by reference.

### BACKGROUND

The present invention relates to the technical field of customizing a presentation of information on an interaction device.

The current related art generally requires manual changing between different types of presentation for control and output. Time-controlled mechanisms which, like screensavers, independently change to an information display after a defined period of time without interaction are also typical. The next interaction (mouse movement, screen touching, etc.), a manual step, prompts a change to be made back to the control mode.

Simple motion detectors which activate a system when a person is detected in the environment are also known. However, a distinction is not made in this case between information output and control; the system is only activated, generally put into an output mode in this case. A manual step would again be required in this case for a conceivable transition to a control mode.

However, the presentation is not altered in relation to the user as regards whether the latter can actually control the device from his current position or whether the information presented can be meaningfully grasped in the output mode.

Systems which activate or deactivate a display in response to approach are likewise known. Proximity sensors in mobile telephones are the best-known example of this. They switch off the display (and the associated touch-sensitive surface) when the telephone is held close to the ear. This is intended to avoid a control element being inadvertently activated as a result of contact with the body when held to the ear. However, this is a purely binary function (on/off) in the immediate vicinity and cannot be expanded to other situations. In both states, the user is close to the device and is therefore theoretically able to control the latter.

User interfaces (human/machine interface, HMI) are generally optimized for their typical use. If inputs are primarily intended to be possible, corresponding control elements are presented. If, however, the display of information is primarily desired, scarcely any or no control elements are present and the information comes to the fore.

### SUMMARY

Therefore, one potential object is flexibly customizing a user interface to use.

According to a first aspect of the inventors' proposal, an interaction device comprises a user interface, a proximity sensor, a logic module and software. The user interface comprises an output device. The software can be executed on the logic module. The software is designed to evaluate data from the proximity sensor and to control the user interface. The proximity sensor is also designed to detect when a user approaches in the visual range of the proximity sensor. The software is designed to use the detected approach to customize a presentation of information on the output device and to refine the presentation of information as the distance between the user and the proximity sensor decreases.

According to another aspect, the inventors propose a method for customizing a presentation of information on an interaction device. In this case, a distance between a user and the interaction device is detected by the interaction device. A presentation of information on the interaction device is then automatically customized by the interaction device using the detected distance. In this case, the presentation of information is automatically refined as the distance of the user decreases.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a block diagram of an interaction device for a building infrastructure;

FIG. 2 shows a view of the interaction device from FIG. 1 together with a flush-mounted box;

FIGS. 3A-3F show an attachment with illustrations of different modes using an air-conditioning system controller; and

FIGS. 4A-4C show attachments in which further programs are offered at the side in the control mode.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

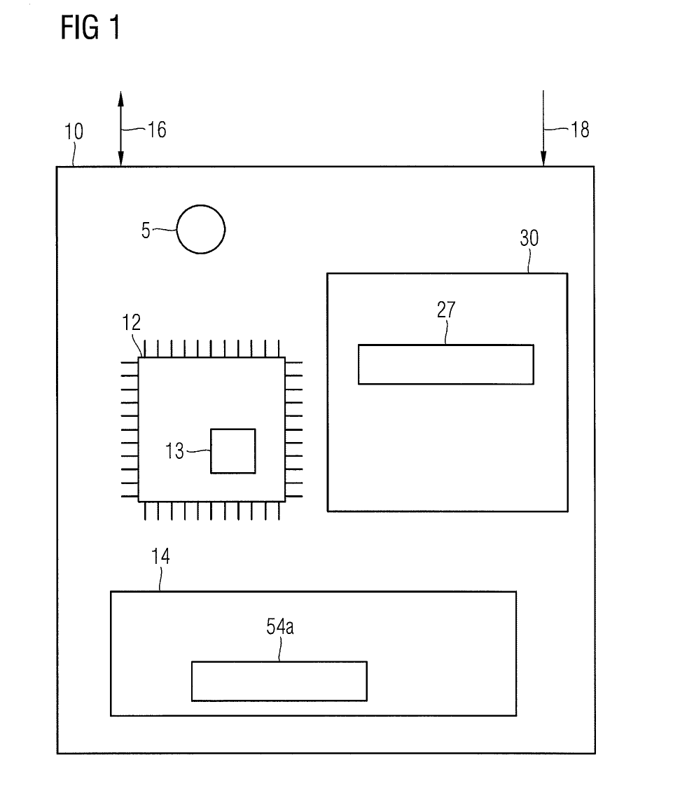

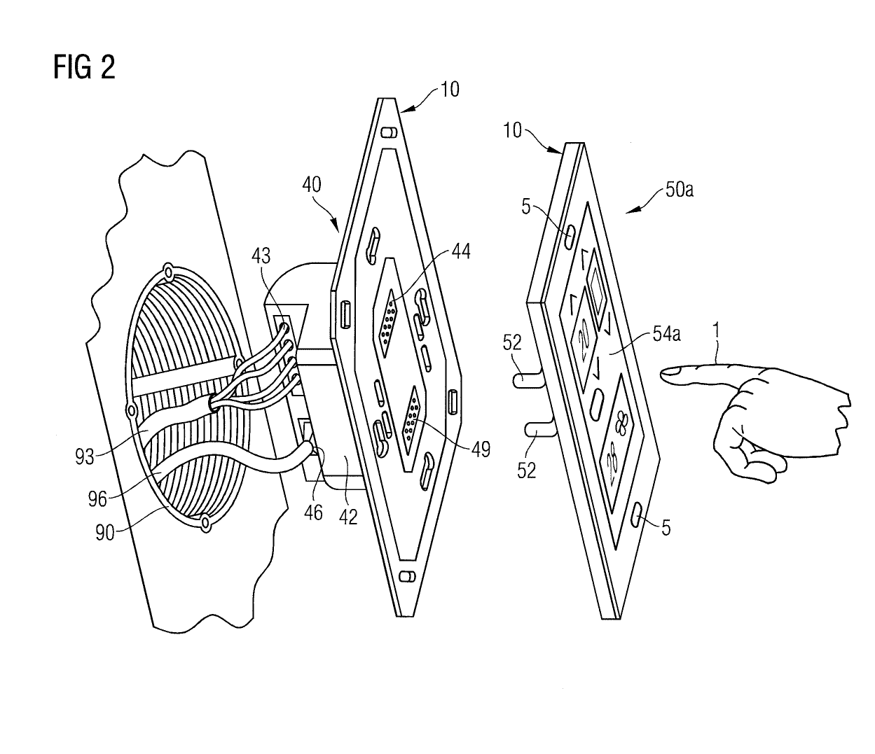

FIGS. 1 and 2 show an interaction device 10 which is designed and/or adapted to control a building infrastructure. The interaction device 10 comprises a user interface 14, a proximity sensor 5, a logic module 12 in the form of a processor or computer system and software 27 which can be executed on the logic module 12. The user interface 14 comprises, as an output device, a touch-sensitive display 54a. The software 27 is designed to evaluate data from the proximity sensor 5 and to control the user interface 14. The proximity sensor 5 is designed to detect when a user 1 approaches in the visual range of the proximity sensor 5. The software is designed to use the detected approach to customize a presentation of information on the output device 54a and to refine the presentation of information as the distance of the user decreases.

Within the scope of this application, the term “proximity/distance sensor” is also used synonymously for the term “proximity sensor”.

According to one preferred embodiment, the detection of approach of the user 1 comprises the determination of a distance between the interaction device 10 and the user 1.

According to another preferred embodiment, the software is designed to receive inputs via an input device. Since the output device is a touch-sensitive display 54a in the exemplary embodiment illustrated in FIG. 1, the output device is simultaneously an input device. In further embodiments, as an alternative or in addition to the touch-sensitive display, the user interface comprises mechanical knobs, buttons and/or switches in the form of input devices.

In this case, the input device 54a and the output device are advantageously integrated with one another, either in a combined device (for instance a touch panel, a touch-sensitive screen) or by being in the local vicinity of one another, for example physical switching elements in the form of knobs, switches, etc., beside or around the output device.

The proximity/distance sensor continuously detects objects in its detection range. Different technologies can be used for this purpose, for instance:
ultrasonic sensors;
infrared sensors;
thermal cameras;
video cameras;
3D reconstruction devices (cf. Microsoft Kinect: http://www.xbox.com/de-DE/Kinect).

Depending on the sensor, sensor values of different quality may be recorded. One difficulty in this case is also the distinction of persons and items. However, objects which remain motionless for a relatively long time may possibly be classified as an item in this case and “dismissed”. According to another preferred embodiment, the software 27 is designed to classify an object which remains motionless for a relatively long time as an item and therefore not to interpret this object as a user 1. However, the sensors need not necessarily primarily detect movement, but rather, to a certain degree, the distance between the sensor and the user/object.

In order to improve the sensor data obtained, different sensors can also be combined with one another.

According to one preferred embodiment, the customization of the presentation of information comprises customization of a display abstraction. When a user moves into the visual range of the proximity/distance sensor 5, the output device 54a is first of all activated, for example woken from the power-saving mode. In this case, the interaction device 10 begins with a coarse information mode. With a decreased distance between the interaction device 10 and the user, the presentation of information in this case is refined in arbitrary discrete stages or else in an infinitely variable manner. The abstraction of the output presentation therefore declines as the distance decreases.

In the direct vicinity of the interaction device 10—it is likely in this case that the user 1 could now actually interact with the device—the interaction device 10 changes to the control mode. The outputs are now optimized for the user to interact with the interaction device 10. This comprises, for example, the selection, manipulation and changing of control elements. The customization of the presentation of information therefore comprises customization of an interaction mode.

Preferred embodiments therefore solve the problem of how the user interface can be flexibly customized to use by automatically changing between control and different output presentations.

This is based on the fact that a user 1 can directly control the interaction device 10 only in the immediate vicinity of the latter. At a certain distance, it is only possible to view the user interface 14. The display of control elements is therefore unnecessary and takes up space. In this case, it is desirable to shift the focus more toward the display of information. In addition, it is desirable to reduce the abundance of information with increasing distance since the human eye can no longer completely resolve the presented information with increasing distance. If the user 1 is even completely outside the visual range of the device, the latter can also save energy and can deactivate the user interface 14.

This therefore results in the following 3 modes:

(1) offline/power-saving mode—the output device (or else the associated overall device) is deactivated or is in a power-saving mode;

(2) information mode (with abstraction levels)—the output device solely presents information;

(3) control mode—the output device shows elements for assisting with input.

In this case, the information mode may have different abstraction levels, alternating in steps or flowing, depending on the distance between the user and the device.

The logic module 12 therefore processes the sensor values in such a manner that the corresponding mode is fixed and, within the information mode, the degree of abstraction is fixed (for example in percent, where 100% corresponds to the coarsest presentation).

FIG. 2 shows the design of an app-based interaction device 10 for a flush-mounted box 90, in this case with a display 54a which can be plugged in. The interaction device 10 comprises the base device 40 for the flush-mounted box 90 and the attachment 50a. The attachment 50a comprises one or more fastening claws 52 and the touch display 54a.

The base device 40 comprises a socket 44 for controlling the display 54a, a socket 49 for controlling further elements on other attachments which can be plugged in, such as for mechanical switches, and a housing 42 in which a communication device is accommodated. The communication device comprises the logic module 12, a radio unit and possible further components. The base device 40 also comprises a bus terminal 43 to which a connection cable 93 for a building control bus system 63 can be connected. The base device 40 also comprises a further terminal 46 to which a further connection cable 96 for a data network can be connected.

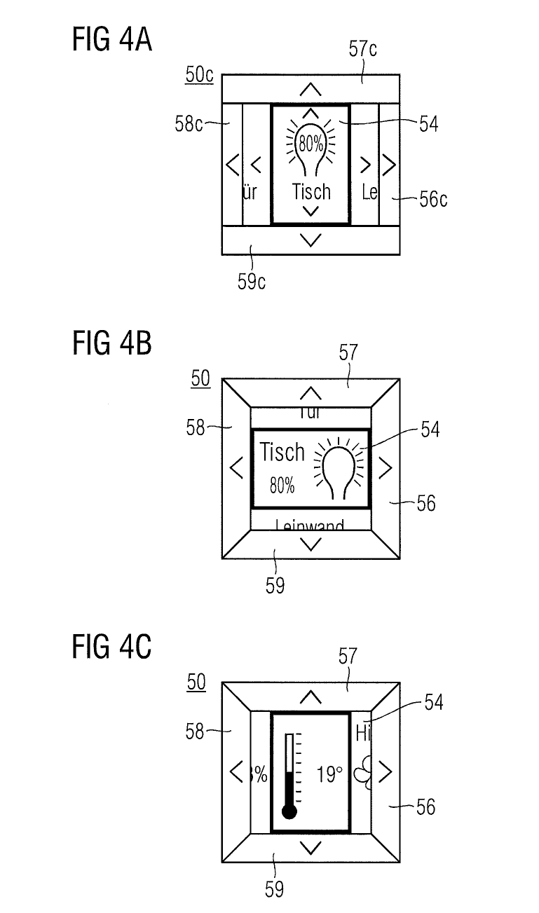

The interaction device 10 itself can preferably be installed in the flush-mounted box 90. The user 1 sees only the touch display 54a on the attachment 50a. The interaction device and, in particular, its user interface can be changed by plugging another attachment, for example one of the attachments 50, 50c described in FIGS. 4A-4C, into the base device.

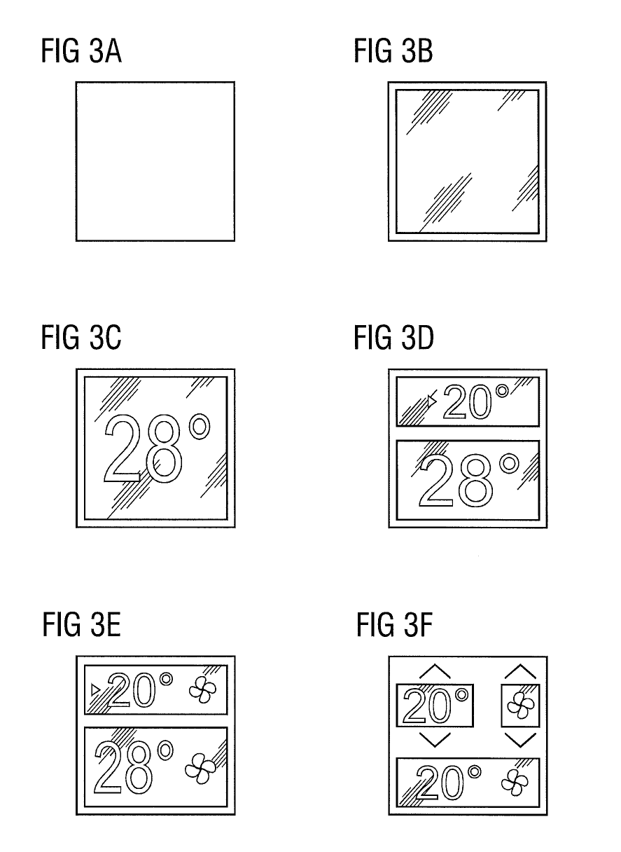

FIGS. 3A-3F show different presentations of information for different modes using an air-conditioning system controller, which presentations are customized by the interaction device on the touch display 54a depending on the distance between a user 1 and the interaction device 10 and are constantly refined as the distance decreases. In this case:

FIG. 3A: shows no user in the visual range: output device 54a is off;

FIG. 3B: shows that the user 1 is ten meters away from the interaction device 10: the output device 54a indicates, only via color coding, whether the target temperature currently prevails, for example blue for “too cold”, red for “too warm” and green for “target temperature prevails”;

FIG. 3C: shows that the user 1 is 5 meters from the interaction device 10: the output device 54a shows the current temperature with color coding in a manner filling the screen;

FIG. 3D: shows that the user 1 is 3 meters from the interaction device 10: the output device 54a displays the current temperature and the target temperature above it;

FIG. 3E: shows that the user 1 is 1.5 meters from the interaction device 10: the output device 54a displays the fan strength which has been set, and possibly also the current strength in the case of an automatic system;

FIG. 3F: shows that the user 1 is directly in front of the interaction device 10: the output device 54a displays the current temperature and the current fan strength on a smaller scale (now at the bottom of the image). The target temperature and the fan mode are illustrated on a large scale, combined with arrows for the change.

In this case, the control mode may also comprise only the change between different items of information or programs to be presented.

Example: only a few centimeters in front of the device, for instance when a finger approaches, other information/programs is/are displayed at the side on a touchscreen (it/they effectively project into the image somewhat); the corresponding information/programs is/are now shifted to the center by “swiping” the screen. When the finger is removed, the elements at the side are cleared again. This is illustrated in FIGS. 4A-4C.

FIG. 4A shows an attachment 50c, an app being executed in order to select individual lights by the rectangular switches 56c, 57c, 58c, 59c and the display 54. The desired lights (for example light on the table) can be selected by the horizontal switches 56c, 58c, and the intensity of the selected light can be selected by the vertical keys 57c, 59c.

FIG. 4B shows the attachment 50, an app being executed in order to select individual lights using the trapezoidal switches 56, 57, 58, 59 and the display 54. In contrast to the embodiment illustrated in FIG. 4A, however, an app is executed in FIG. 4B in which the desired light can be selected by the vertical switches 56, 58, while the intensity of the light can be selected by the horizontal switches 57, 59.

FIG. 4C shows the attachment 50, an app being executed in order to control the temperature, humidity and ventilation. The temperature, humidity or ventilation and the relevant desired values therefor can be set using the switches 56, 57, 58, 59. The display displays the respective selection and the respective target value.

Optionally, the direction of the user in relation to the combined output/input device can also be taken into account. If the user is standing in front of the interaction device, for example, and moves his hand at the right-hand edge of the interaction device, control elements can be presented primarily on the right when changing from the pure information mode to the control mode (possibly useful only on touch-sensitive screens).

Preferred embodiments include the advantageous combination of the following functions:
determining the distance between the device and the user;
processing the distance values in terms of mode and possibly abstraction level;
preparing the user interface according to mode and possibly abstraction level.

The advantages of this solution are:
reduction in the complexity of the user interface with increasing distance;
important information can also be grasped from a great distance;
display of control elements for input only when the user is actually able to exercise control from his current position;
cost saving and lower space requirement in comparison with conventional solutions in which, for example, an LED for a remotely readable status display is combined with a touch display for control;
cost saving as a result of power-saving/offline mode when there is no user in the vicinity. Displays can be deactivated.

The proposed controller can be installed in various devices which are provided for input/output. These may be both expansions of conventional desktop or tablet computers but also information carousel systems, information terminals, HMI interfaces for production devices, etc.

In particular, a form for display-assisted interaction devices in building control is also conceivable, as shown in FIG. 2, which shows a form with a plug-in attachment 50 for a flush-mounted control device 10. The proximity sensors 5 are connected to a touchscreen 54a in a plug-in attachment 50.

According to preferred embodiments, an interaction device 10 in the building changes between different display abstractions and interaction modes depending on the distance of the user. Example for a heating and air-conditioning system controller in the room in a flush-mounted device: if there is no user in the room, the device is off. If a user is 10 m away, the entire display appears only in one color, for example blue for “too cold”, red for “too warm” and green for “target temperature reached”. The closer the user comes to the device, the more information appears: the current temperature, the target temperature, the ventilation mode. If the user comes within reach of the device, operating elements (for example arrows) for adjusting the target temperature and the ventilation mode appear. A proximity sensor is used in this case.

The proposals are preferably used in relatively complex building control interaction devices. Further possible uses are in vending machines (for example for tickets), information kiosks (at railway stations or airports) or in billboards.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. An interaction device comprising:
a user interface including an output device;
a proximity sensor configured to detect when a user approaches in a visual range of the proximity sensor; and
a processor configured to use the detected approach to control the user interface by customizing a presentation of information on the output device and refine the presentation of the information as a distance between the user and the proximity sensor decreases.

2. The interaction device as claimed in claim 1,
wherein the customizing of the presentation of the information includes customizing of a display abstraction.

3. The interaction device as claimed in claim 1, wherein
the customizing of the presentation of the information includes customizing of an interaction mode, the customizing of the interaction mode including a change between ones of the following modes or selection of one or more of the following modes:
an offline/power-saving mode in which the output device is deactivated or is in a power-saving mode;
an information mode in which the output device solely presents information; and
a control mode in which the output device shows elements for assisting with input.

4. The interaction device as claimed in claim 1,
wherein the detection of approach of the user includes determining a distance between the interaction device and the user.

5. The interaction device as claimed in claim 1,
wherein the interaction device is designed and/or adapted to control a building infrastructure.

6. The interaction device as claimed in claim 1,
wherein the output device is a display and the presentation of the information on the display is customized using the detected approach.

7. The interaction device as claimed in claim 1, wherein the user interface includes an input device and the processor is configured to receive inputs via the input device, the input device including knobs, buttons, switches and/or at least one touch-sensitive surface belonging to a display.

8. The interaction device as claimed in claim 1,
wherein the processor is configured to classify an object that remains motionless for longer than a predetermined time as an item other than a user.

9. A method for customizing a presentation of information on an interaction device, the method comprising:
detecting a distance between a user and the interaction device; and
customizing the presentation of the information on the interaction device using the detected distance and refining the presentation of the information as a distance of between the user and the interaction device decreases.

10. The method as claimed in claim 9,
wherein the customizing of the presentation of the information includes customizing of a display abstraction.

11. The method as claimed in claim 9, wherein
the customizing of the presentation of the information includes customizing of an interaction mode, the customizing of the interaction mode including a change between ones of the following modes or selection of one or more of the following modes:
an offline/power-saving mode in which the output device is deactivated or is in a power-saving mode;
an information mode in which the output device solely presents information; and
a control mode in which the output device shows elements for assisting with input.

12. The method as claimed in claim 9,
wherein the interaction device is designed and/or adapted to control a building infrastructure.

13. The method as claimed in claim 9,
wherein the interaction device includes a display and the presentation of the information on the display is customized using the detected approach.

14. The method as claimed in claim 9,
wherein the interaction device includes knobs, buttons, switches and/or at least one touch-sensitive surface belonging to a display.

15. The method as claimed in claim 9,
wherein objects that remain motionless for longer than a predetermined time are automatically classified as an items other than a user.

16. A non-transitory computer-readable medium encoded with a computer program for customizing a presentation of information on an interaction device, the program when executed by a computer causes the computer to perform a method comprising:
detecting a distance between a user and the interaction device; and
customizing the presentation of the information on the interaction device using the detected distance and refining the presentation of the information as a distance of between the user and the interaction device decreases.
